(19) United States
(12) Patent Application Publication
(10) Pub. No.: US 2007/0291299 A1
(43) Pub. Date: Dec. 20, 2007

(54) System and method for generating location based content

(75) Inventors: Fabio M. Gava, Ladera Ranch, CA (US); Alok Mathur, Lake Forest, CA (US); Silvy J. Wilson, Rancho Santa Margarita, CA (US)

Correspondence Address: TUCKER ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha

(21) Appl. No.: 11/452,764

(22) Filed: Jun. 14, 2006

(51) Int. Cl. G06F 3/12

(52) U.S. Cl. 358/1.15

(57) ABSTRACT

The subject application is directed to a system and method for generating location based content via a document processing device. Location data representing the location of the document processing device is first stored in an associated storage, along with data representing services associated with the document processing device. A user is first prompted, via an associated user-interface, to select a desired service, which is associated with a specific network service provider. The network address of each service provider is stored in the data storage in correlation with the service to which the provider is associated. The user then selects a desired service, whereupon the device generates a query including the device location data and submits the query to the service provider corresponding to the selected service. The device then receives a response from the service provider and outputs the response to the user.

### BACKGROUND OF THE INVENTION

The subject application is directed to a system and method for generating location based content via a selected document processing device. More particularly, the subject application is directed to a system and method for providing selected content to a user of a document processing device based on the location of such device.

An increasing amount of location based services are being offered via the Internet in order for users to obtain information pertaining to a certain geographic area. Examples of such services include directions to or from a specified location to another location, weather forecasts for a specified location, local news for a specified location, and point of interest search for a specified location. In order to access such information, a user requires a computer or other similar device with the ability to access the Internet. Once the user has accessed the desired location based service via the Internet, the user is typically requested to provide the address or zip code for the user's location. After the user has received the desired location based information, the user may desire a hard copy of such information. The user will then have to transmit the received information from the computing device to a document processing device for output of the information. If the user is using a handheld device or is not in an office environment, transmitting the information to a document processing device may be difficult. For a handheld device, the device must either have the capability to connect to a document processing device, either via a wired or wireless communication channel, or the user will have to store the information on a portable storage medium, wherein the information is transmitted via such medium to the document processing device. If the user is not in an office environment, the user will need to access the information via a computing device in communication with a document processing devices. Document processing devices in a public facility are generally not in data communication with a computing device which may be accessed via a mobile user. Typically, the mobile user will have to pay a fee to use a computing device to access the information and save the information to a portable storage medium. The user will then have to pay a fee to use the document processing device in order to output a hard copy of the information. As such, there is a need for a document processing device with the ability to provide location based content to a user.

The subject application overcomes the above noted problems and provides a document processing device which can generate location based content.

### SUMMARY OF THE INVENTION

In accordance with the subject application, there is provided a system and method for generating location based content via a selected document processing device.

Further, in accordance with the subject application, there is provided a system and method for providing selected content to a user of a document processing device based on the location of such device.

Still further, in accordance with the subject application, there is provided a location aware shared document processing device. The device includes a network interface adapted for data communication with an associated network. The device also includes means adapted for storing location data representative of geographic location of the document processing device and means adapted for receiving input from an associated user. The device further includes means adapted for prompting the user for selection of at least one of a plurality of geographically related document processing services and means adapted for storing network address data associated with a network service provider corresponding to each of the plurality of geographically related document processing services. The device also comprises means adapted for receiving, from the associated user, selection data representative of at least one geographically related document processing service selected from the plurality thereof and means adapted for submitting a query corresponding to the selection data, via the network interface, to at least one selected network service provider in accordance with network address data corresponding thereto. The device further includes means adapted for receiving, via the network interface, response data from each selected network provider and output means adapted for generating an output to the associated user corresponding to received response data.

Preferably, the selection data includes data representative of a request for localized information corresponding to the location data including at least one of map information, local service provider information, local weather information, local news information, local event information, and local product supplier information.

In one embodiment, the output includes a map showing locations corresponding to the response data. Preferably, the device further includes document rendering means adapted for generating a hard copy corresponding to the output.

In another embodiment, the device further comprises means adapted for receiving secondary selection data from the associated user corresponding to generated output. In a more preferred embodiment, the device also includes means adapted for submitting a second query corresponding to the secondary selection data, via the network interface, to at least one selected network service provider in accordance with network address data corresponding thereto and means adapted for receiving, via the network interface, secondary response data from each selected network provider associated with the secondary selection data. In addition, the output means including means adapted for generating a secondary output to the associated user corresponding to received secondary response data.

Still further, in accordance with the subject application, there is provided a method for generating location based content via the document processing device as described above.

Still other advantages, aspects and features of the subject application will become readily apparent to those skilled in the art from the following description wherein there is shown and described a preferred embodiment of this invention, simply by way of illustration of one of the best modes best suited to carry out the invention. As it will be realized, the invention is capable of other different embodiments and its several details are capable of modifications in various obvious aspects all without departing from the scope of the invention. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of the system generating location based content via a document processing device according to the subject application;

FIG. 2 is a block diagram illustrating controller hardware for use in the system for generating location based content via a document processing device according to the subject application;

FIG. 3 is a functional block diagram illustrating the controller for use in the system for generating location based content via a document processing device according to the subject application; and

FIG. 4 is a flowchart illustrating a method for generating location based content via a document processing device according to the subject application.

### DETAILED DESCRIPTION OF THE PREFERRED EMBODIMENT

The subject application is directed to a system and method for generating location based content via a selected document processing device. In particular, the subject application is directed to a system and method for providing selected content to a user of a document processing device by such device. More particularly, the subject application is directed to a system and method for providing location specific information to a user of a document processing device based upon the geographic location of the device.

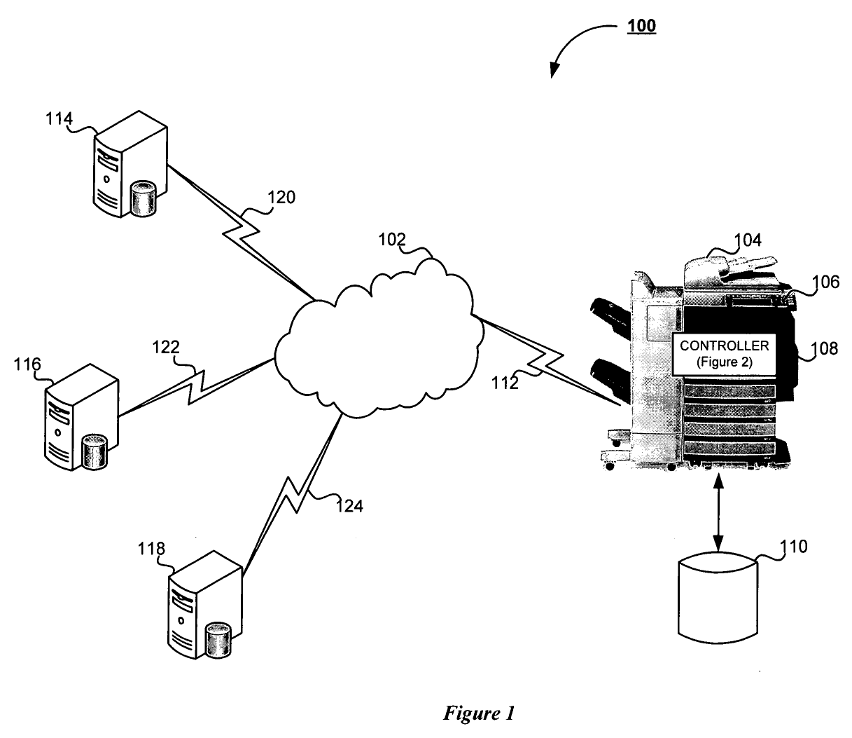

Referring now to FIG. 1, there is shown an overall diagram of the system 100 for generating location based content via a document processing device in accordance with the subject application. As shown in FIG. 1, the system 100 employs a distributed computing environment, represented as a computer network 102. It will be appreciated by those skilled in the art that the computer network 102 is any distributed communications environment known in the art capable of enabling the exchange of data between two or more electronic devices. Those skilled in the art will further appreciate that the network 102 is any computer network known in the art including, for example and without limitation, a personal area network, a wide area network, a local area network, a virtual local area network, an intra net, the Internet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms.

The system 100 depicted in FIG. 1 further incorporates at least one document processing device 104, represented as a multifunction peripheral device, suitably adapted to perform a variety of document processing operations. The skilled artisan will understand that such document processing operations include, for example and without limitation, copying, scanning, electronic mail, document management, facsimile, printing, and the like. Suitable commercially available document processing devices include, for example and without limitation, the Toshiba e-Studio Series Controller. In accordance with one aspect of the subject application, the document processing device 104 is suitably adapted to provide an associated user with the ability to request predefined information related to the geographical area local to the document processing device 104. Preferably, the document processing device 104 includes hardware, software, and any suitable combination thereof, configured to interact with the associated user and provide such information thereupon.

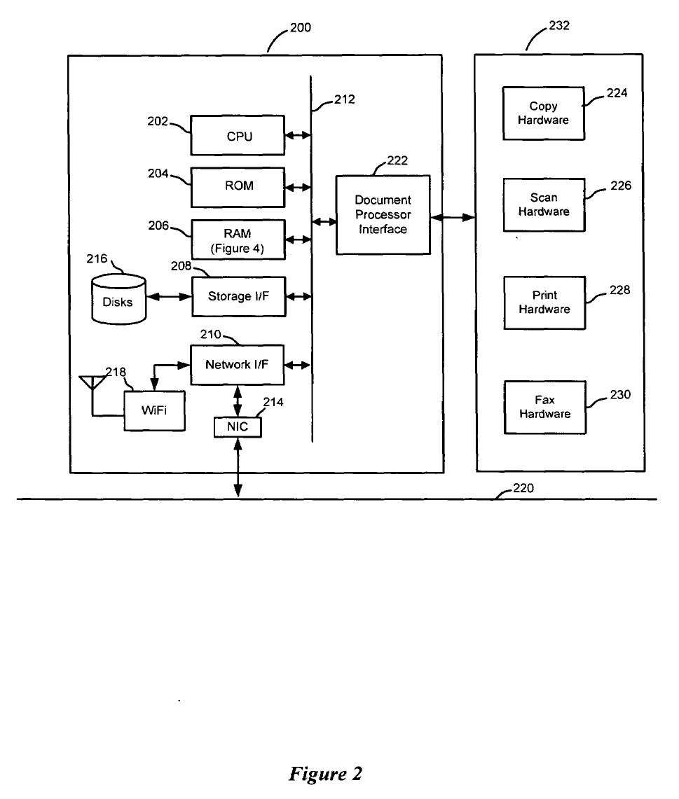

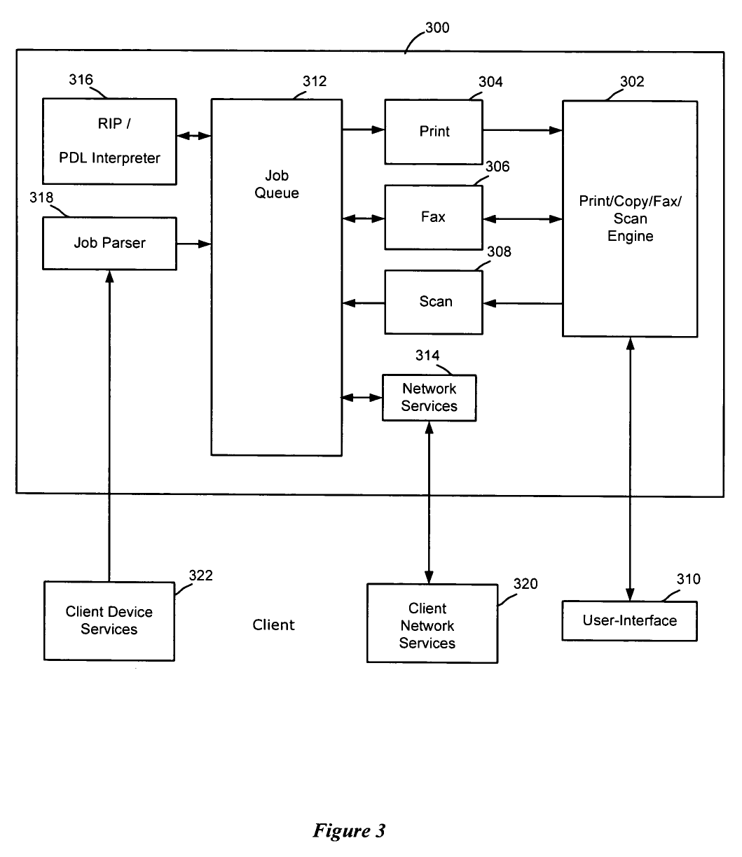

In one embodiment, the document processing device 104 is suitably equipped to receive a plurality of portable storage media, including without limitation, Firewire drive, USB drive, SD, MMC, XD, Compact Flash, Memory Stick, and the like. In the preferred embodiment of the present invention, the document processing device 104 further includes an associated user-interface 106, such as a touch-screen interface, LCD display, or the like, via which an associated user is able to interact directly with the document processing device 104. In accordance with the preferred embodiment of the subject application, the user-interface 106 is advantageously used to communicate information to the associated user and receive selections from the user. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. In accordance with the subject application, the first document processing device 104 further incorporates a controller 108, suitably adapted to facilitate the operations of the first document processing device 104, as will be understood by those skilled in the art. Preferably, the controller 108 is embodied as hardware, software, or any suitable combination thereof, configured to control the operations of the associated document processing device 104, control the display of images via the user-interface 106, and the like. The functioning of the controller 108 will better be understood in conjunction with the block diagrams illustrated in FIGS. 2 and 3, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store information relative to the location of the document processing device 104, e.g., a street address, postal code, and the like, information related to the local geographic area, data representative of a network address of network service providers, and the like. It will be appreciated by those skilled in the art that while illustrated in FIG. 1 as being a separate component of the system 100, the data storage device 110 is capable of being implemented as internal storage of the document processing device 104, such as, for example and without limitation, an internal hard disk drive, or the like.

As shown in FIG. 1, the system 100 also employs a plurality of network service providers, illustrated as the network service provider server 114, the network service provider server 116, and the network service provider server 118. Preferably, these network service providers 114, 116, and 118 are suitably equipped to provide a variety of services to a user associated with the document processing device 104. Suitable services include, for example and without limitation, driving directions, area maps, points-of-interest, news, weather, and the like. More preferably, these network service providers 114, 116, and 118 are web-based servers, suitably configured to communicate information via the computer network 102. The skilled artisan will appreciate that the network service provider servers 114, 116, and 118 are any software, hardware, or combination thereof, suitably adapted to provide network services via the computer network 102. In accordance with one aspect of the subject application, the service providers 114, 116, and 118 include pre-defined content, corresponding to the geographic location of the document processing device 104 including, for example and without limitation, driving directions from the document processing device 104 location to another location, an area map of the location of the device 104, points-of-interest around the location of the device 104, local news for the location of the device 104, weather forecast for the location of the device 104, restaurants located in proximity to the location of the device 104, and the like.

The skilled artisan will appreciate that the subject application is preferably implemented such that the computer network 102 is the Internet, with each network service provider 114, 116, 118 providing a web-page for viewing. It will further be appreciated by those skilled in the art that the network service providers 114, 116, and 118 are communicatively coupled to the computer network 102 via a suitable communications link 120, 122, and 124, respectively. The communications links 120, 122, and 124 are any suitable means of data communication known in the art, including, for example and without limitation, infrared, optical, a proprietary communications network, the public switched telephone network, Bluetooth, WiMax, 802.11a, 802.11b, 802.11g, or 802.11(x), or any other suitable wire-based or wireless data transmission means known in the art. In accordance with the preferred embodiment of the subject application, the service providers 114, 116, and 118 are accessible via a web-browser using a network address, e.g., an IP address, or the like.

Turning now to FIG. 2, illustrated is a representative architecture of a suitable controller 200, shown in FIG. 1 as the controller 108, on which operations of the subject system 100 are completed. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. Network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and network interface subsystem 210 is suitably accomplished via a bus data transfer mechanism, such as illustrated by bus 212.

Also in data communication with bus 212 is a document processor interface 222. Document processor interface 222 suitably provides connection with hardware to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that a controller suitably operates any or all of the aforementioned document processing operations. Systems accomplishing more than one document processing operation are commonly referred to as multifunction peripherals or multifunction devices.

Functionality of the subject system is accomplished on a suitable document processing device that includes the controller 200 of FIG. 2 as an intelligent subsystem associated with the document processing device 104. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably via an interface local to the controller, or remotely via a remote thin or thick client.

The engine 302 is in data communication with printer function 304, facsimile function 306, and scan function 308. These devices facilitate the actual operation of printing, facsimile transmission and reception, and document scanning for use in securing document images for copying or generating electronic versions.

A job queue 312 is suitably in data communication with printer function 304, facsimile function 306, and scan function 308. It will be appreciated that various image forms, such as bit map, page description language or vector format, and the like, are suitably relayed from scan function 308 for subsequent handling via job queue 312.

The job queue 312 is also in data communication with network services 314. In a preferred embodiment, job control, status data, or electronic document data is exchanged between job queue 312 and network services 314. Thus, suitable interface is provided for network based access to the controller 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. Network services 314 also advantageously supplies data interchange with client side services 320 for communication via FTP, electronic mail, TELNET, or the like. Thus, the controller function 300 facilitates output or receipt of electronic document and user information via various network access mechanisms.

Job queue 312 is also advantageously placed in data communication with an image processor 316. Image processor 316 is suitably a raster image process, page description language interpreter or any suitable mechanism for interchange of an electronic document to a format better suited for interchange with device services such as printing 304, facsimile 306 or scanning 308.

Finally, job queue 312 is in data communication with a parser 318, which parser suitably functions to receive print job language files from an external device, such as client device services 322. Client device services 322 suitably include printing, facsimile transmission, or other suitable input of an electronic document for which handling by the controller function 300 is advantageous. Parser 318 functions to interpret a received electronic document file and relay it to a job queue 312 for handling in connection with the afore-described functionality and components.

In operation, the controller 108 associated with the document processing device 104, stores on the data storage device 110, information corresponding to the location of the device 104. That is, the controller 108 stores data representing the location of the document processing device 104, such as, for example and without limitation, a postal code, a street address, a latitude/longitude, or the like. Preferably, such data is retrieved by the controller 108 associated with the document processing device 104 via the computer network 102. It will be appreciated by those skilled in the art that the location data associated with the document processing device 104 is suitably capable of being retrieved via a local area network, using a global positioning system receiver in data communication with the document processing device 104, via a cellular-based positioning system, or the like. A user, associated with the document processing device 104, is then prompted by the controller 108 to select a service from among a list of available services via the associated user-interface 106. Preferably, the controller 108 retrieves a list of services available to the user from the data storage device 110 and displays this listing to the user via the associated user-interface 106. The data storage device 110 further includes the network address of the providers 114, 116, and 118 of the services contained in the listing displayed to the user.

For example, service provider 114 corresponds to a map-based service, service provider 116 corresponds to a news and weather service, and service provider 118 corresponds to a point-of-interest-based service, the network address of each being stored in the data storage device 110. It will be understood by those skilled in the art that use of network service providers 114, 116, and 118 as described herein is for example purposes only, and the subject application is capable of implementing a plurality of servers for use in accordance with the methodologies contained herein. In a further example, service provider 114 is capable of corresponding to an event-based service provider, service provider 116 corresponds to a product-based service provider, and service provider 118 corresponds to a local news-based service provider, the network address of each being stored in the data storage device 110.

The controller 108 associated with the document processing device 104, via the user-interface 106, receives user selection data and submits a query to the network service provider 114, 116, or 118 corresponding to the selected service. Thus, for example, when the user has selected a local news and/or weather service, a query for the local news and/or weather is sent, via the computer network 102, from the controller 108 associated with the document processing device 104 to the corresponding network service provider 116. The corresponding network service provider 116 receives the request and returns a response inclusive of the requested information. It will be appreciated by those skilled in the art that the controller 108 uses the stored device 104 location information to correlate the query such that local information is returned. The controller 108 then generates an output to the user, via the user-interface 106, corresponding to the query response from the network service provider 114, 116, or 118. In accordance with the preferred embodiment of the subject application, the output by the document processing device 104 is capable of including, for example and without limitation, a hard copy output of the response, or the like. It will be appreciated by those skilled in the art that the controller 108 associated with the document processing device 104 implements a suitable web-browser or other suitable software to retrieve the requested information from a publicly available XML web service. In accordance with one aspect of the subject application, the output containing the requested information further includes a map showing locations corresponding to the response received from the corresponding network service provider 114, 116, or 118.

The controller 108 then determines whether additional selection data is warranted or has been received from the associated user. That is, the controller 108 associated with the document processing device 104 determines whether the response requires further user selections, so as to narrow down the results, center a map, display restaurants, display product suppliers, additional information regarding a previous request, or the like. When no additional input from the user is required or forthcoming, the operation terminates. When a secondary or additional query is to be generated, the controller 108 associated with the document processing device 104 receives the secondary or additional user selection data from the user via the associated user-interface 106. The controller 108 then generates a suitable query for the corresponding network service provider 114, 116, or 118 and submits the query to that respective network service provider 114, 116, or 118. The network service provider 114, 116, or 118 receives the query and generates a response, which is then returned to the document processing device 104. The controller 108 associated with the document processing device 104 then generates a secondary/additional output corresponding to the response for the user. As stated above, the output is capable of taking the form of a display via the user-interface 106, a hard copy output, or the like, as desired by the user issuing the request.

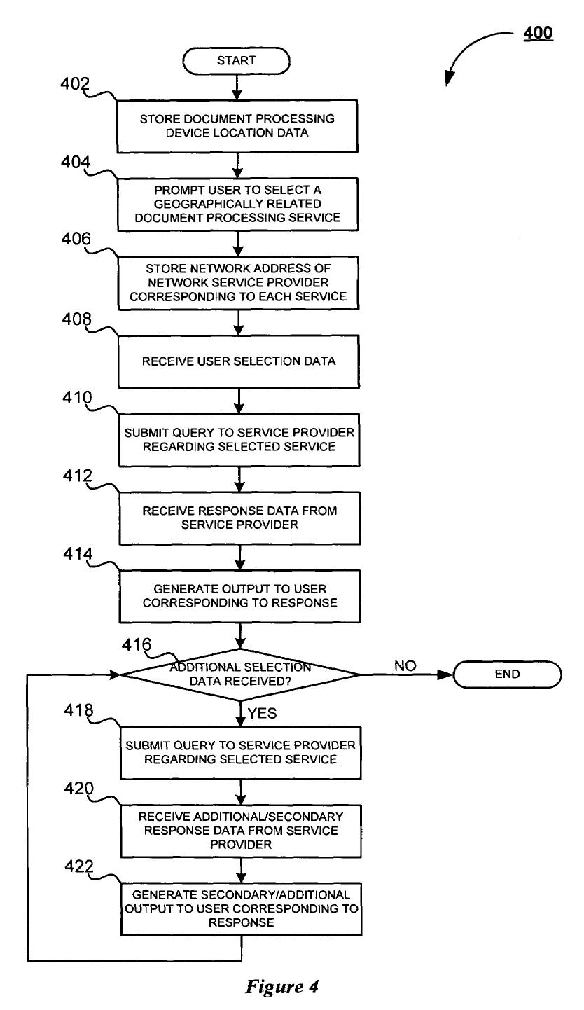

The foregoing system 100 will better be understood when viewed in conjunction with the methodology described in FIG. 4. Turning now to FIG. 4, there is shown a flowchart 400 illustrating a method for generating location based content via a document processing device in accordance with the subject application. Operations begin at step 402, whereupon the controller 108 associated with the document processing device 104 stores location data representative of the location of the document processing device 104. Preferably, this location data is stored in the associated data storage device 110 communicatively coupled to the document processing device 104. As the skilled artisan will appreciate, the location data is capable of including, for example and without limitation, a postal code, a street address, a city, a latitude/longitude coordinate value, or the like. At step 404, the user is prompted, via the associated user-interface 106, to select a geographically related document processing service. Preferably, the document processing device 104 includes a store of information relating to services located in relative proximity to the document processing device 104. Suitable services include, for example and without limitation, map services, weather services, news services, local event services, product supplier services, local news services, and the like.

At step 406, the controller 108 associated with the document processing device 104 stores the network address of each network service provider 114, 116, and 118. Each network service provider 114, 116, and 118 corresponds to a given service. User selection data corresponding to the user's selection of one or more services is then received by the document processing device 104 via the associated user-interface 106 at step 408. At step 410, the controller 108 generates a query corresponding to the user's selected service and submits the query to the network service provider 114, 116, or 118 associated with the selected service. It will be understood by those skilled in the art that such a query is advantageously submitted via the computer network 102 to the network address associated with the network service provider 114, 116, 118 designated by the selected service. For example, when the user has selected an area map of the location of the document processing device 104, the controller 108 generates a query, inclusive of the document processing device's location data and submits the query to the corresponding network service provider, e.g., network service provider 114. The network service provider 114 then uses the location data supplied by the controller 108 associated with the document processing device 104 to retrieve an area map corresponding to the location of the document processing device 104 and returns this map data as a response to the submitted query.

The controller 108 then receives the response data from the service provider 114, 116, or 118 at step 412; whereupon an output is generated to the user corresponding to the response at step 414. It will be appreciated by those skilled in the art that step 414 enables the controller 108 associated with the document processing device 104 to display, via the associated user-interface 106, the response data to the user, as well as outputting a hard copy of the response data to the user. A determination is then made at step 416 whether additional selection data has been received from the user. That is, the controller 108 determines, at step 416, whether the user's initial selection requires further selection data, e.g., a map to be narrowed done, further information regarding a local event, five-day forecast, hourly forecast, reverse driving directions, or the like. When no additional or secondary selection data has been received from the user at step 416, the operation terminates. When additional or secondary selection data has been received at step 416, flow proceeds to step 418, whereupon the controller 108 associated with the document processing device 104 generates a query, inclusive of the location data, corresponding to the secondary or additional selection data and submits the query to the network service provider 114, 116, or 118 corresponding to the additional or secondary selection data.

The designated network service provider 114, 116, or 118 receives the query and compiles a response corresponding to the request, which is then transmitted via the computer network 102 to the document processing device 104. The response from the network service provider 114, 116, or 118 is then received by the controller 108 associated with the document processing device 104 at step 420 corresponding to the additional or secondary selection data. The controller 108 then generates a secondary or additional output to the user corresponding to the response at step 422. As previously discussed, suitable output formats for the response data include, for example and without limitation, a hard copy, a visual display on the associated user-interface 106, or the like. In accordance with the preferred embodiment of the subject application, the controller 106 associated with the documents processing device, the hard copy output is capable of including, for example and without, a map detailing the location of each service, item, event, news, weather, or the like, based upon the response from the corresponding service provider.

The invention extends to computer programs in the form of source code, object code, code intermediate sources and partially compiled object code, or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A location aware shared document processing device comprising:
a network interface adapted for data communication with an associated network;
means adapted for storing location data representative of geographic location of the document processing device;
means adapted for receiving input from an associated user,
means adapted for prompting the user for selection of at least one of a plurality of geographically related document processing services;
means adapted for storing network address data associated with a network service provider corresponding to each of the plurality of geographically related document processing services;
means adapted for receiving, from the associated user, selection data representative of at least one geographically related document processing service selected from the plurality thereof;
means adapted for submitting a query corresponding to the selection data, via the network interface, to at least one selected network service provider in accordance with network address data corresponding thereto;
means adapted for receiving, via the network interface, response data from each selected network provider; and
output means adapted for generating an output to the associated user corresponding to received response data.

2. The location aware shared document processing device of claim 1 wherein the selection data includes data representative of a request for localized information corresponding to the location data including at least one of map information, local service provider information, local weather information, local news information, local event information, and local product supplier information.

3. The location aware shared document processing device of claim 2 wherein the output includes a map showing locations corresponding to the response data.

4. The location aware shared document processing device of claim 3 further comprising document rendering means adapted for generating a hard copy corresponding to the output.

5. The location aware shared document processing device of claim 2 further comprising means adapted for receiving secondary selection data from the associated user corresponding to generated output.

6. The location aware shared document processing device of claim 5 further comprising:
means adapted for submitting a second query corresponding to the secondary selection data, via the network interface, to at least one selected network service provider in accordance with network address data corresponding thereto;
means adapted for receiving, via the network interface, secondary response data from each selected network provider associated with the secondary selection data; and
the output means including means adapted for generating a secondary output to the associated user corresponding to received secondary response data.

7. A method for generating location based content via a document processing device comprising the step of:
storing location data representative of geographic location of an associated document processing device in data communication with an associated network via a network interface;
prompting the user for selection of at least one of a plurality of geographically related document processing services;
storing network address data associated with a network service provider corresponding to each of the plurality of geographically related document processing services;
receiving, from the associated user, selection data representative of at least one geographically related document processing service selected from the plurality thereof;
submitting a query corresponding to the selection data, via the network interface, to at least one selected network service provider in accordance with network address data corresponding thereto;
receiving, via the network interface, response data from each selected network provider; and
generating an output to the associated user corresponding to received response data.

8. The method for generating location based content via a document processing device of claim 7 wherein the selection data includes data representative of a request for localized information corresponding to the location data including at least one of map information, local service provider information, local weather information, local news information, local event information, and local product supplier information.

9. The method for generating location based content via a document processing device of claim 8 wherein the output includes a map showing locations corresponding to the response data.

10. The method for generating location based content via a document processing device of claim 9 further comprising the step of generating a hard copy corresponding to the output.

11. The method for generating location based content via a document processing device of claim 8 further comprising the step of receiving secondary selection data from the associated user corresponding to generated output.

12. The method of generating location based content via a document processing device of claim 11 further comprising the steps of:
submitting a second query corresponding to the secondary selection data, via the network interface, to at least one selected network service provider in accordance with network address data corresponding thereto;
receiving, via the network interface, secondary response data from each selected network provider associated with the secondary selection data; and
generating a secondary output to the associated user corresponding to received secondary response data.

13. A computer-implemented method for generating location based content via a document processing device comprising the step of:
storing location data representative of geographic location of an associated document processing device in data communication with an associated network via a network interface;
prompting the user for selection of at least one of a plurality of geographically related document processing services;
storing network address data associated with a network service provider corresponding to each of the plurality of geographically related document processing services;
receiving, from the associated user, selection data representative of at least one geographically related document processing service selected from the plurality thereof;
submitting a query corresponding to the selection data, via the network interface, to at least one selected network service provider in accordance with network address data corresponding thereto;
receiving, via the network interface, response data from each selected network provider; and
generating an output to the associated user corresponding to received response data.

14. The computer-implemented method for generating location based content via a document processing device of claim 13 wherein the selection data includes data representative of a request for localized information corresponding to the location data including at least one of map information, local service provider information, local weather information, local news information, local event information, and local product supplier information.

15. The computer-implemented method for generating location based content via a document processing device of claim 14 wherein the output includes a map showing locations corresponding to the response data.

16. The computer-implemented method for generating location based content via a document processing device of claim 15 further comprising the step of generating a hard copy corresponding to the output.

17. The computer-implemented method for generating location based content via a document processing device of claim 14 further comprising the step of receiving secondary selection data from the associated user corresponding to generated output.

18. The computer-implemented method of generating location based content via a document processing device of claim 17 further comprising the steps of:
submitting a second query corresponding to the secondary selection data, via the network interface, to at least one selected network service provider in accordance with network address data corresponding thereto;
receiving, via the network interface, secondary response data from each selected network provider associated with the secondary selection data; and
generating a secondary output to the associated user corresponding to received secondary response data.
